(19) United States
(12) Patent Application Publication
(10) Pub. No.: US 2011/0019228 A1
(43) Pub. Date: Jan. 27, 2011

(54) INFORMATION PROCESSING APPARATUS, INFORMATION PROCESSING METHOD AND PRINT MEDIUM

(75) Inventor: Shinichi Uchikawa, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/834,817

(22) Filed: Jul. 12, 2010

(30) Foreign Application Priority Data
Jul. 23, 2009 (JP) 2009-172439

(51) Int. Cl. G06F 3/12; H04B 7/00

(52) U.S. Cl. 358/1.15; 455/41.3

(57) ABSTRACT

In a case where in an information processing apparatus of setting one of plural printers where communication is possible, as a print output destination to make the set printer perform print output, it is determined whether or not a newly connected printer is present, and the printer is detected and is not set as the print output destination, the output destination is automatically changed to the printer connected by short-distance wireless by automatically changing the setting of the print output destination to the printer in which the detection is detected.

### BACKGROUND OF THE INVENTION

1. Field of the Invention

The present invention relates to an information processing apparatus, and particularly in detail to an information processing apparatus which performs a print by selectively using one of plural available information forming apparatuses.

2. Description of the Related Art

Conventionally an information processing apparatus (mainly personal computer (PC)) can set and store plural print output destinations and in a case of performing a print, selects an output destination in use out of the plural output destinations for outputting the print.

In addition, since it is troublesome to select the output destination each time of performing the print, a general OS lets a user set a frequently used print output destination as a standard output destination to eliminate a labor of selecting the output destination at each time of printing.

An example of methods for automatically changing the standard output destination includes a technology where in a case of being incapable of communicating with the existing standard output destination, an image forming apparatus (printer) in which communication is possible is automatically set as a new standard output destination (for example, refer to Japanese Patent Laid-Open No. 2007-105937). In this technology, however, the image forming apparatus set as the standard output destination can be used, but in a case of desiring to use an image forming apparatus other than the set image forming apparatus, the use can not be realized.

In recent years, printers have been operable by short-distance wireless communication (wireless communication technology where an effective range of Transfer-Jet, Bluetooth or the like is several meters at a maximum). Followed by it, a user has a tendency of selectively use plural printers corresponding to a situation or a location without limiting used printers to one printer.

In a case where the information processing apparatus is connected to plural printers by short-distance wireless, there is a high possibility of setting the print output destination not only to the printer set as the standard output destination but also to the printer connected by the short-distance wireless.

However, in a case where in an environment where the plural print output destination settings are stored in the information processing apparatus, a user sets the print output destination to the printer connected by the short-distance wireless, it is necessary for the user to seek the printer connected by the short-distance wireless out of the print output destination settings stored at printing and designate it as an output destination. This job is troublesome for the user, and when the user selects the other printer by mistake, a print is outputted from the unintended printer, resulting in diminishing an operation efficiency of the user.

In addition, in a system of setting and using the standard output destination, such as a system using a general OS, in a case where a user does not set a printer connected by short-distance wireless as the standard output destination, it is necessary to change the output destination to the printer connected by the short-distance wireless at each time of printing.

For avoiding the trouble of changing the output destination at each time of printing, there is considered a method where at the time of connecting a printer by short-distance wireless, a user changes the standard output destination to the printer connected by the short-distance wireless. However, not only such an operation is troublesome for the user but also in a case where the connection by the short-distance wireless is cut off, there occurs the necessity of once again changing the standard output destination to the other printer.

The present invention has an object of improving convenience in a case of using a printer connected by short-distance wireless.

### SUMMARY OF THE INVENTION

For solving the above-mentioned problem, according to the present invention, an information processing apparatus connectable to plural image forming apparatuses comprises a unit configured to set a first image forming apparatus to a print output destination among the plural image forming apparatuses, a detecting unit configured to detect a second image forming apparatus which is an image forming apparatus having a driver and connected by short-distance wireless communication, a determining unit configured to, when the detecting unit detects the second image forming apparatus, determine whether or not the second image forming apparatus is set to the print output destination, and a setting changing unit configured to, when the determining unit determines that the second image forming apparatus is not set to the print output destination, change the second image forming apparatus to the print output destination.

According to the present invention, in a case of using the image forming apparatus connected by the short-distance wireless, since the information processing apparatus automatically sets the output destination, it is not necessary for a user to manually select the output destination. Further, when a disconnection of the short-distance wireless communication is detected, the information processing apparatus is automatically restored to the output destination setting before connected, and therefore, it is not necessary for the user to manually restore the output destination to the previous output destination.

In addition, in a case of not setting the output destination automatically, the information processing apparatus in advance confirms the output destination, determines the possibility that the incorrect output destination is set, and requests a user for its confirmation. Therefore, it is possible to prevent an erroneous print by an unintended image forming apparatus.

Further features of the present invention will become apparent from the following description of exemplary embodiments with reference to the attached drawings.

### BRIEF DESCRIPTION OF THE DRAWINGS

FIG. 1 is a system configuration diagram explaining a first embodiment of the present invention;

FIG. 2 is a hardware configuration diagram showing an information processing apparatus for carrying out the present invention;

FIG. 3 is the system configuration diagram explaining the first embodiment of the present invention;

FIG. 4 is an internal module configuration diagram showing the information processing apparatus in the first embodiment;

FIG. 5 is a flow chart showing an output destination setting in the first embodiment;

FIG. 6 is a flow chart showing an output destination restoration setting in the first embodiment;

FIG. 7 is a system configuration diagram explaining a second embodiment of the present invention;

FIG. 8 is the system configuration diagram explaining the second embodiment of the present invention;

FIG. 9 is a flow chart showing an output destination setting in the second embodiment;

FIG. 10 is a system configuration diagram explaining a third embodiment of the present invention;

FIG. 11 is an internal module configuration diagram showing an information processing apparatus in the third embodiment; and

FIG. 12 is a flow chart showing a determination on output destination appropriateness in the third embodiment.

### DESCRIPTION OF THE EMBODIMENTS

### First Embodiment

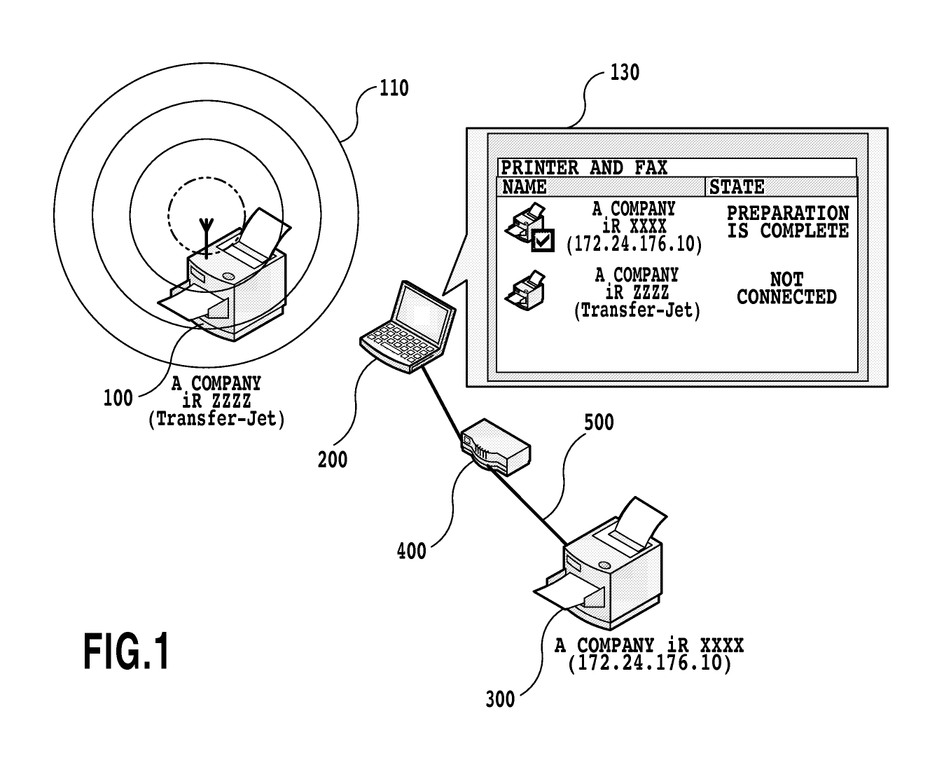

By referring to FIG. 1, there will be explained a first embodiment where in a case where an information processing apparatus (hereinafter, referred to as client) is newly connected to a printer as an image forming apparatus by short-distance wireless, a print output destination is automatically set to the printer connected by the short-distance wireless.

For example, it is assumed that there exist a printer 100 for printing an image, a document or the like connectable in a short distance to a client by Transfer-Jet, and a printer 300 and a client 200 connected through LAN 500 to a rooter 400. Concentric circles show a communication range of Transfer-Jet as a model, and the communication range is a range to the vicinity of the outermost circle.

Here, the connection between the printer 100 and the client 200 is not established by Transfer-Jet and the printer 100 is registered as the output destination in the client 200, but is not set as a standard output destination (refer to a selective screen 130). The printer 300 is set as the standard output destination. When a user performs a print from the client 200 in this state, the print is performed in the printer 300 as long as the setting of the print destination is not changed.

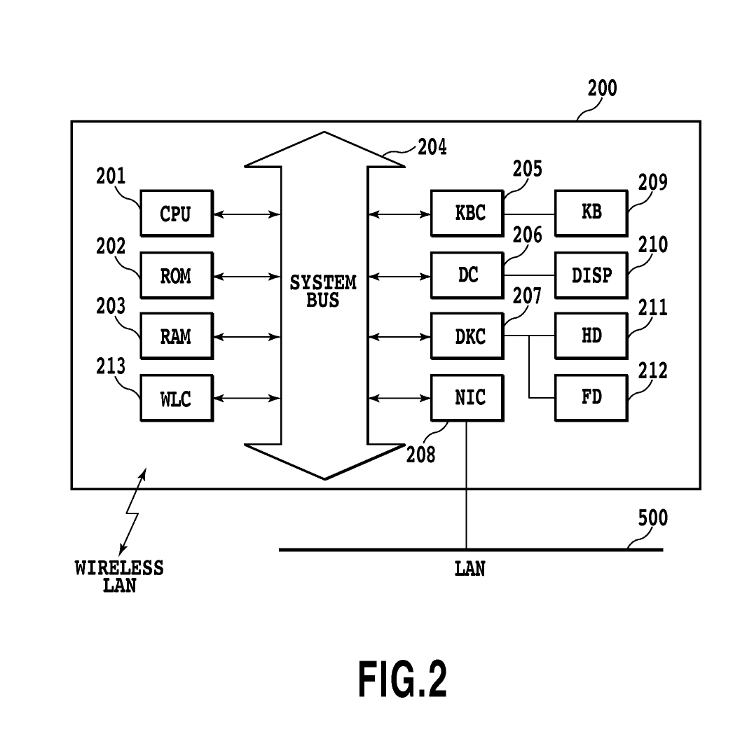

Here, the client 200 is, for example, a handy lap top PC and has a hardware structure shown in FIG. 2 in the same way as a general PC. That is, the client 200 has a CPU 201 carrying out various kinds of software stored in a ROM 202 or a hard disc (HD) 211 or supplied from a floppy (registered trademark) disc drive (FD) 212. The CPU 201 controls respective elements connected to a system bus 204 totally.

A RAM 203 serves as a main memory, a work area and the like of a main memory. A key board controller (KBC) 205 controls instruction input from a keyboard (KB) 209, a pointing device (not shown) and the like. A display controller (DC) 206 controls a display of a display (DISP) 210.

A disc controller (DKC) 207 controls access to the hard disc (HD) 211 and the floppy (registered trademark) disc drive (FD) 212. The hard disc (HD) 211 and the floppy (registered trademark) disc drive (FD) 212 store therein a boot program, a dispersion server system program, various types of applications, an editing file, a user file and the like. A network interface card (NIC) 208 is a device for exchanging data to and from a network printer, a different network device or PC through (wired) LAN 500 interactively.

A wireless LAN card (WLC) 213 is a device for exchanging data to and from a network printer, a different network device or a PC through wireless LAN interactively. The WLC 213 detects electric field strength, a wireless frequency and the like of the wireless LAN in close proximity thereto corresponding to Transfer-Jet and Bluetooth and provides these pieces of information to the CPU 201. The CPU 201 controls the NIC 208 and the WLC 213 to carry out communication through any of LANs.

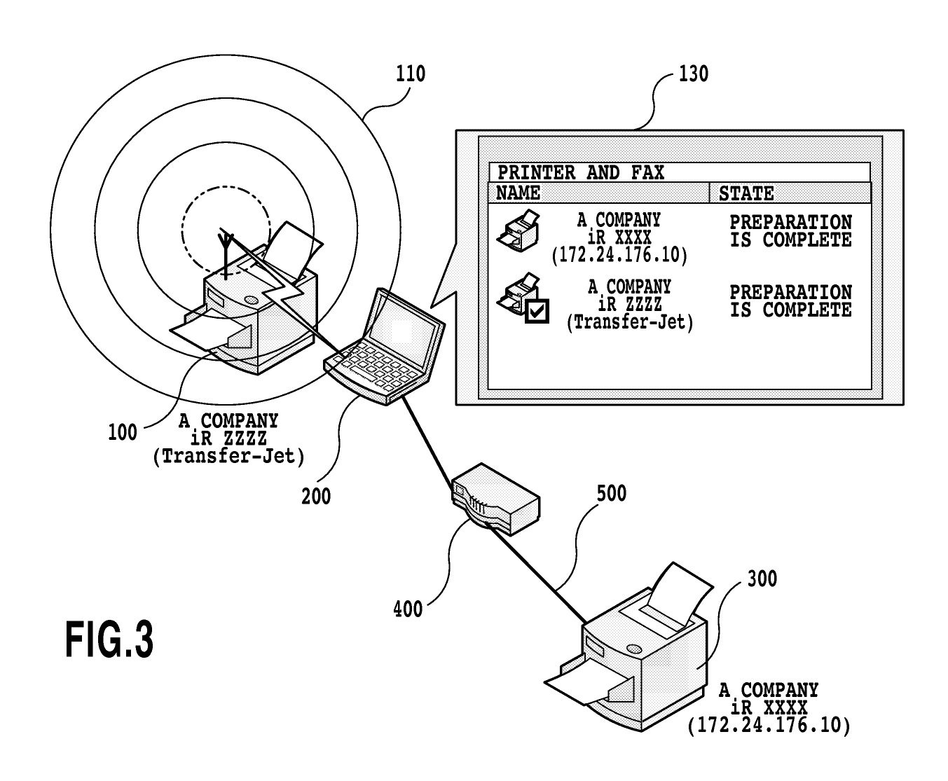

A case where the client 200 in such a situation as shown in FIG. 1 has a short-distance connection to the printer 100 through Transfer-Jet will be explained with reference to FIG. 3.

When the client 200 detects the connection to the printer 100 by Transfer-Jet, the setting of the standard output destination is changed from the printer 300 to the printer 100. (in the selective screen 130 in FIG. 1, a check mark showing the standard output destination is attached to the printer 300, but in the selective screen 130 in FIG. 3, the check mark is attached to the printer 100)

When a user instructs a print in this state, the print is outputted from the printer 100. In this way, the user can automatically output the print in the printer 100 connected by Transfer-Jet without intentionally changing the printer for outputting to the printer 100.

It is assumed that the user (that is, client 200) who has completed the print in the printer 100 leaves away from the printer 100 and moves out of the communication range of Transfer-Jet as shown in FIG. 1. When the client 200 detects that the communication with Transfer-Jet is disconnected, the standard output destination is restored to a state before the printer 100 is connected by Transfer-Jet. In the present embodiment, the setting of the standard output destination is restored from the printer 100 to the printer 300.

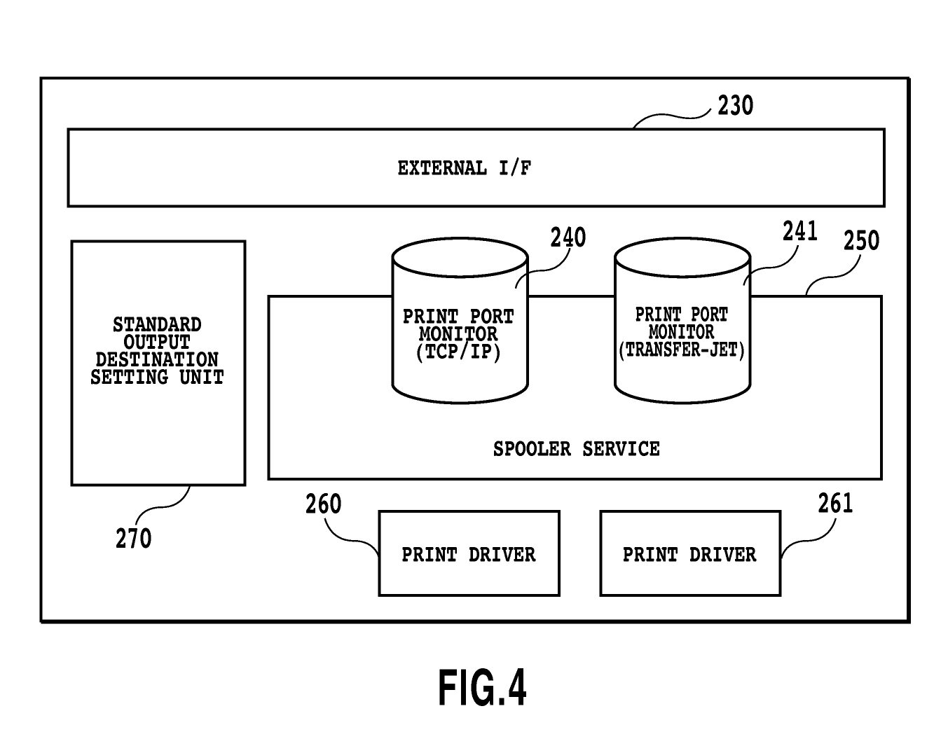

FIG. 4 shows an internal module structure of the client 200 for carrying out the present embodiment. The client 200 is configured by an external I/F′ module 230, print port monitors 240 and 241 communicating with the printer, a spooler service 250 for managing the monitor, printer drivers 260 and 261 for generating print data and a standard output destination setting unit 270. The print port monitor 240 is communicated with the printer by Transfer-Jet and the print port monitor 241 is communicated with the printer by TCP/IP.

The external I/F module 230 is provided with communication functions for making short-distance wireless communication, TCP/IP communication, USB and serial communication. The standard output destination setting unit 270 is provided with a function for automatically determining and setting the standard output destination and is a resident application periodically monitoring a state of the printer. The print drivers 260 and 261 respectively are associated with the print port monitors 240 and 241.

Here, the print driver 260 is associated with the print port monitor 240, and the print driver 261 is associated with the print port monitor 241. A combination of the print driver 260 and the print port monitor 240 is set as the standard print output destination.

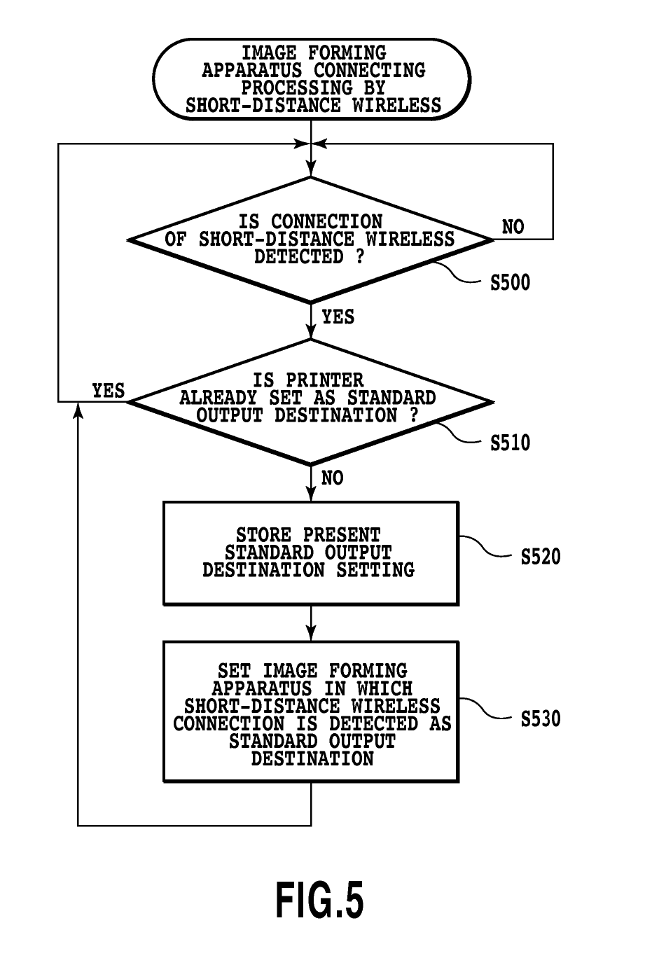

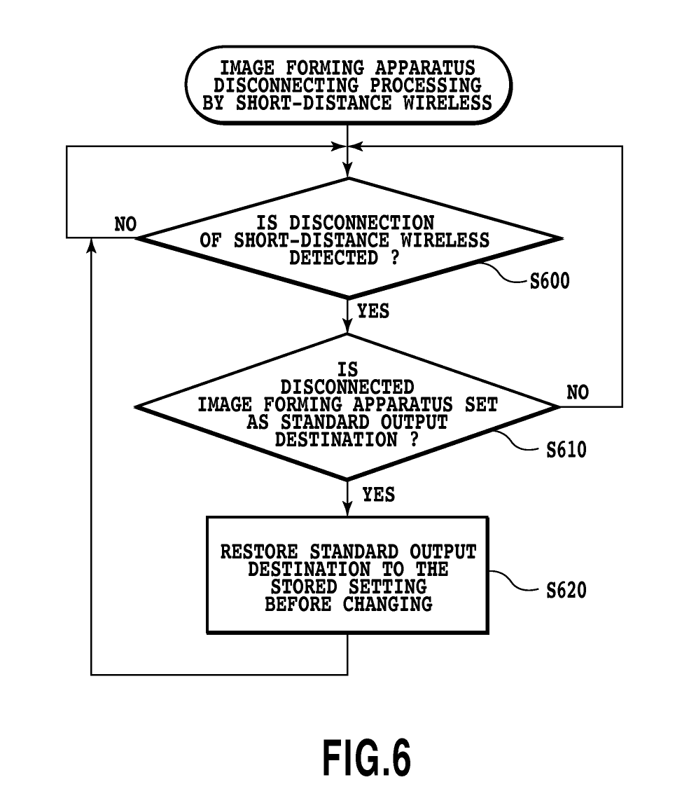

An internal processing flow of the client 200 realizing the present embodiment will be explained with reference to FIG. 4 and FIGS. 5 and 6 respectively showing an operation flow of the standard output destination setting unit 270. The processing of the flow charts in FIGS. 5 and 6 and the processing of each flow chart in the following embodiment are realized by reading out the program stored in the print medium 202, 211 or 212 as a code and executing it by the PC or the like.

In the connecting processing shown in the flow chart in FIG. 5, the standard output destination setting unit 270 first determines whether or not the connection of the printer 100 by Transfer-jet is detected (S500). This processing is executed by obtaining transport information of the print port monitors 240 and 241 from the spooler service 500 for determination. Alternatively the determination may be made by obtaining the communication information from the printer 100. Further, the determination may be made by obtaining a connection situation of a short-distance wireless communication from an OS (operating system) by which the client 200 operates.

When the client 200 changes from the non-connection state in FIG. 1 to a connection state to the printer 100 by Transfer-Jet, the standard output destination setting unit 270 detects the short-distance wireless connection and the process goes to step S510, wherein it is confirmed to the spooler service 250 whether or not the printer 100 is already set as the standard output destination. As a result, in a case where the printer 100 is set as the standard output destination, the process goes back to the connection detection determining processing of step S500, and in a case where the printer 100 is not set as the standard output destination, the present standard output destination (in a case of FIG. 1, the printer 300) is temporarily stored. (S520). The area for the storing may be a file system or a memory and is not limited particularly. After storing the present standard output destination, the print driver 261 using the print port 241 making communications by Transfer-Jet corresponding to the printer 100 connected at present is set as the standard output destination (S530), and the process goes back to the connection detection determining processing of step S500.

Next, a case where the client 200 establishing the short-distance connection to the printer 100 by Transfer-Jet as shown in FIG. 3 cuts off the short-distance connection will be explained with reference to a flow chart in FIG. 6.

When a user with the printer 200 moves out of the communication range of Transfer-Jet to cut off the connection to the printer 100 by Transfer-Jet, the standard output destination setting unit 270 detects the disconnection of the short-distance wireless communication (S600: Yes). In addition, the present standard output destination setting is confirmed (S610). As a result, when it is determined that the standard output destination stays in a state of being setting to the printer 100 cut off in communication (S610: Yes), the setting of the standard output destination is changed to the printer 300 which is the previous output destination stored at step S520 in FIG. 5 (S620).

By the processing of FIGS. 5 and 6, only when the client 200 is connected to the printer 100 by Transfer-Jet, the printer 100 is automatically set as the standard output destination. In a case where the client 200 is not connected to the printer 100 by Transfer-Jet, the standard output destination can be automatically set to the printer 300 for use.

As described above, according to the present embodiment, in a case where a printer which has set some image forming apparatus as the standard output destination enters into the short-distance wireless communication range of another image forming apparatus, the image forming apparatus connected by short-distance wireless can be automatically set as a printer of the standard destination.

### Second Embodiment

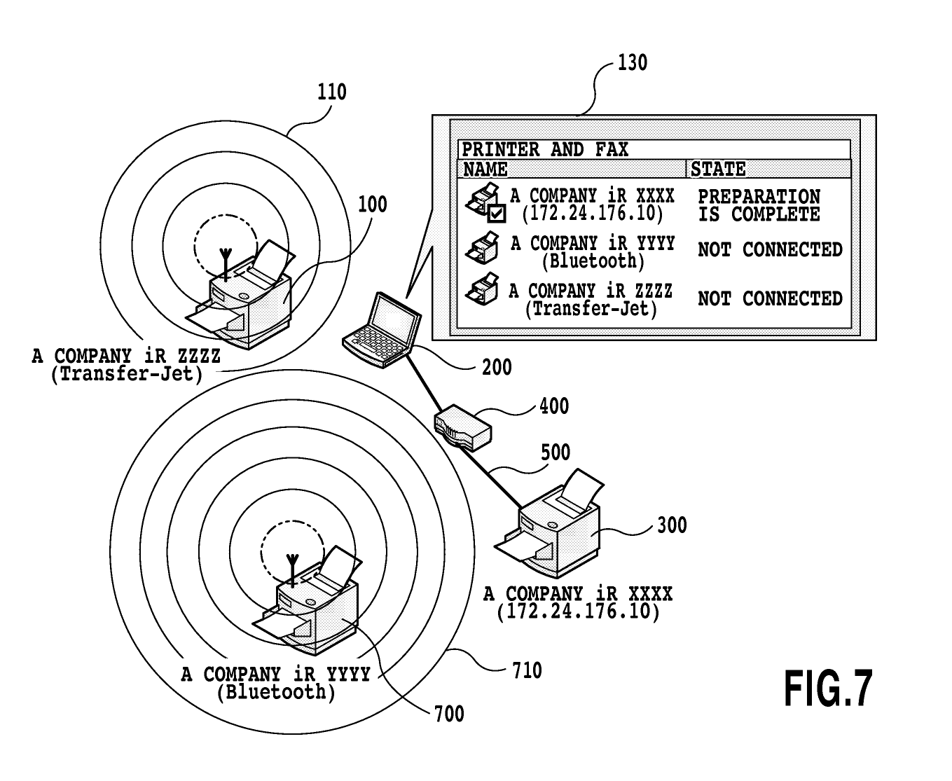

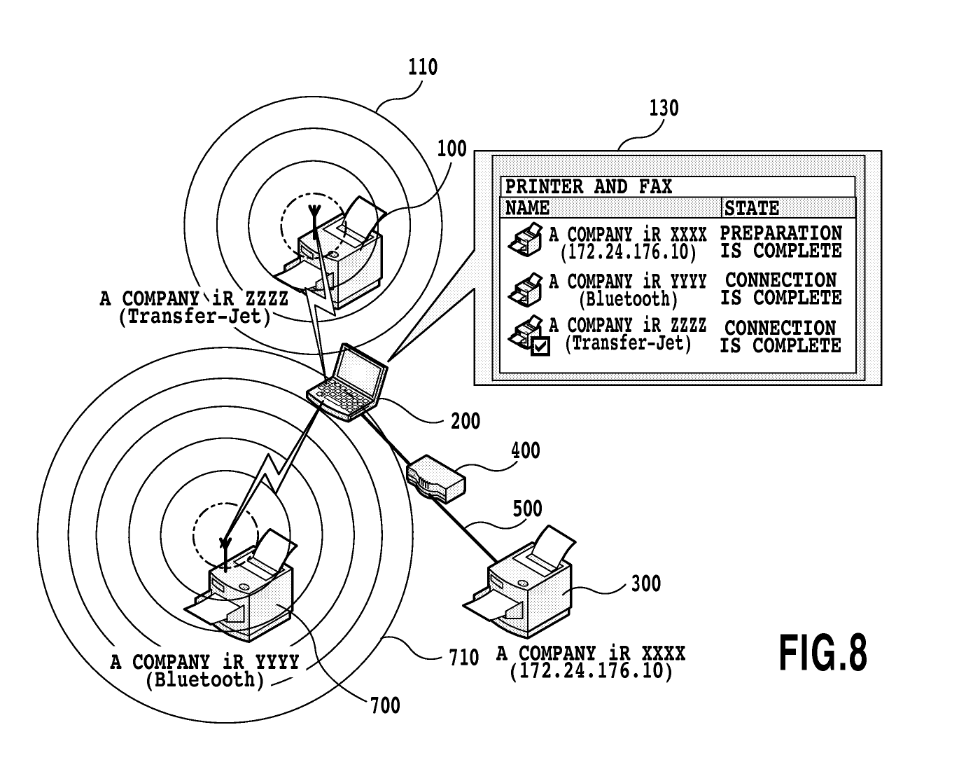

As an embodiment developed from the first embodiment, there will be explained a case where one client is simultaneously connected to plural printers by different short-distance wireless communication systems (Transfer-Jet and Bluetooth) as shown in FIGS. 7 and 8.

A printer 700 in FIG. 7 is provided with Bluetooth and the communication range is shown in concentric circles 710. In this figure, the client 200 is not within any of the communication ranges of the printer 100 and the printer 700 and the printer 300 is set as the standard output destination (refer to the selective screen 130).

FIG. 8 shows a state where a use with the client 200 enters into a communication range 110 of the printer 100 and a communication range 710 of the printer 700. In this case, the client 200 is connectable to the printer 100 by Transfer-Jet and to the printer 700 by Bluetooth.

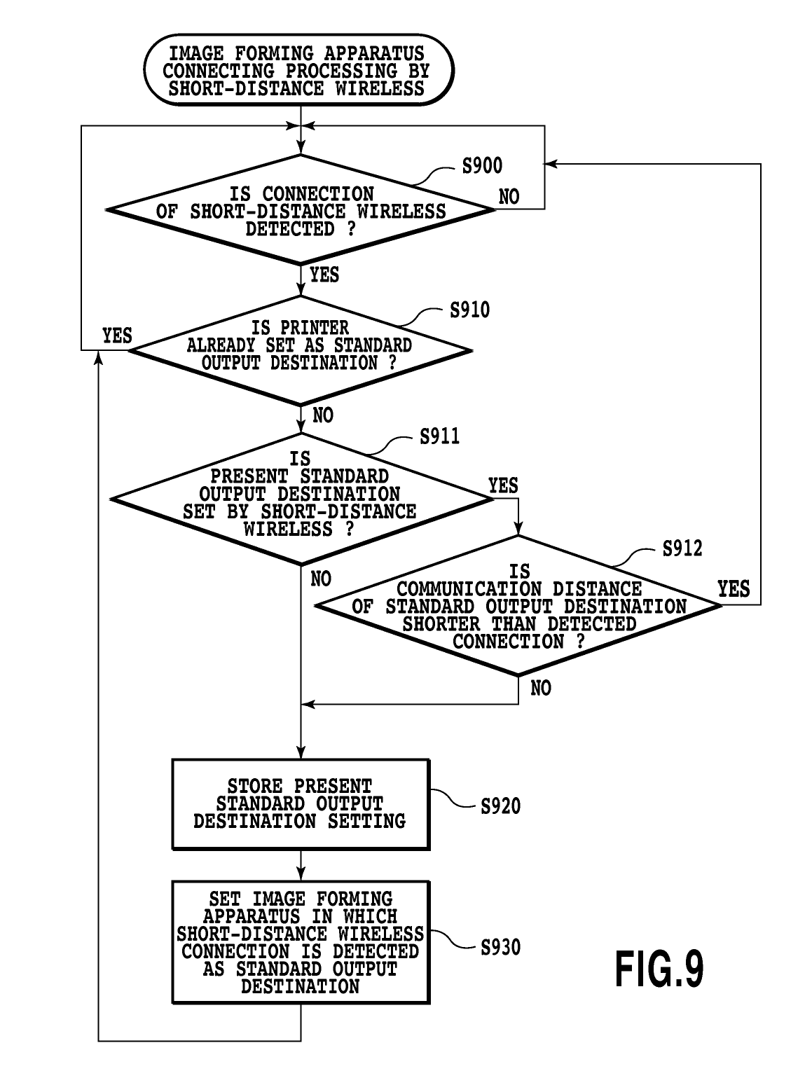

In a case of the state in FIG. 8, even if the client 200 is connected by Transfer-Jet and Bluetooth both of which are short-distance wireless communication, since the communication range 110 of Transfer-Jet is narrower than the communication range 710 of Bluetooth, there is a higher possibility that the user is present in close proximity to the printer 100 with Transfer-Jet. Therefore, there is a higher possibility that it is convenient for the user to use the printer 100 connected by Transfer-Jet. For coping with such a case, the present embodiment executes the connecting processing as shown in a flow chart in FIG. 9 where the connecting processing in FIG. 5 in the second embodiment is expanded.

The processing of steps S900, S910, S920 and S930 in FIG. 9 respectively is identical to that of steps S500, S510, S520 and S590. In a case where a printer in a short-distance wireless connection newly detected is not set as the standard output destination, in the present embodiment, the process goes to step S911, wherein it is determined whether or not the present set output destination is the printer connected by the short-distance wireless. When it is determined that it is connected by the short-distance wireless, the process goes step S912, wherein it is determined whether or not the communication range (communication distance) of the printer is shorter than that of the printer in the short-distance wireless connection newly detected. When not shorter, steps S920 and S930 are executed. In consequence, when the client 200 is simultaneously connected to the plural printers by different short-distance wireless systems, one printer 100 connected by the short-distance wireless communication technology having a narrower communication range is set as the standard output destination. (in the selective screen 130 of FIG. 7, a check mark showing the standard output destination is attached to the printer 300 and in the selective screen 130 of FIG. 8, a check mark showing the standard output destination is attached to the printer 100.)

It should be noted that in a case where an effective communication range of the printer in the short-distance wireless connection newly detected is the same as that of the printer in the short-distance wireless connection set as the output destination at present (the same in communication system), a user may be required to select the output destination. That is, a popup dialogue screen is displayed to select the output destination, setting the printer selected by the user as the output destination.

As described above, in a case where the client enters into the plural short-distance wireless communication ranges, it is possible to automatically set the printer connected by the short-distance wireless having a shorter communication distance as the output destination.

### Third Embodiment

Many users think that it is convenient to automatically change and set the standard output destination and the output destination, but there are some cases where a user does not want to change the standard output destination depending on a situation. For meeting such a demand, in the present embodiment, an appropriateness determination of the output destination on whether or not the printer set as the output destination is appropriate is made at timing when the user instructs a print, without automatically changing the setting of the output destination. In a case where it is not appropriate, a warning is given to the user to promote the setting change.

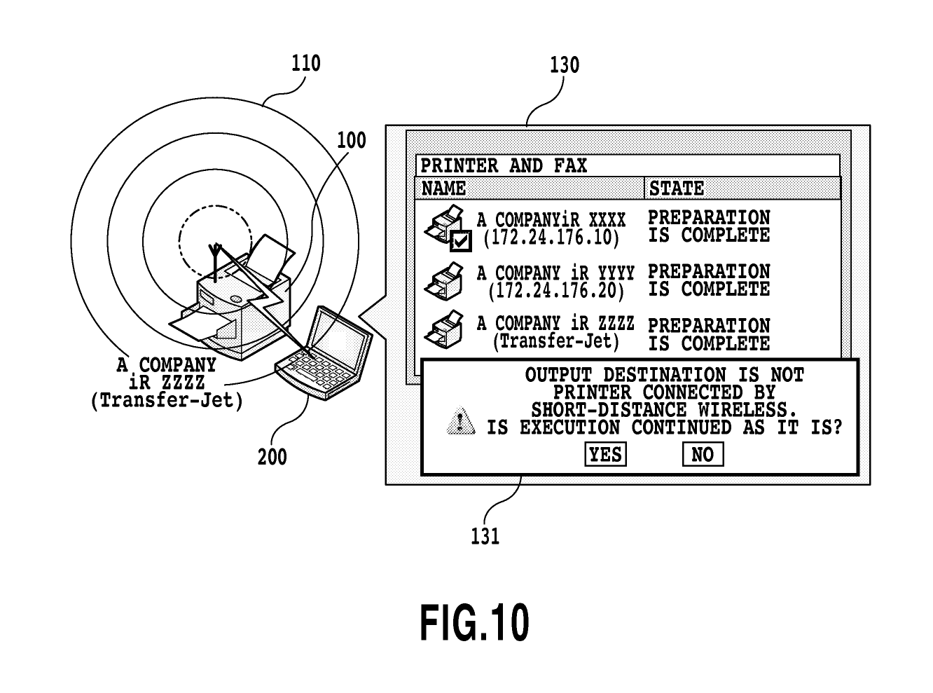

FIG. 10 shows a state where the printer 100 is connected by Transfer-Jet to the client 200 in which an apparatus (not shown) other than the printer 100 is set as the standard output destination.

In a case where in this state a user is desired to perform a print from a printer (A company iRXXXX) of the standard output destination using the client 200, it is confirmed that the output destination is not the printer 100 connected by Transfer-Jet by presenting the popup dialogue 131 to the user.

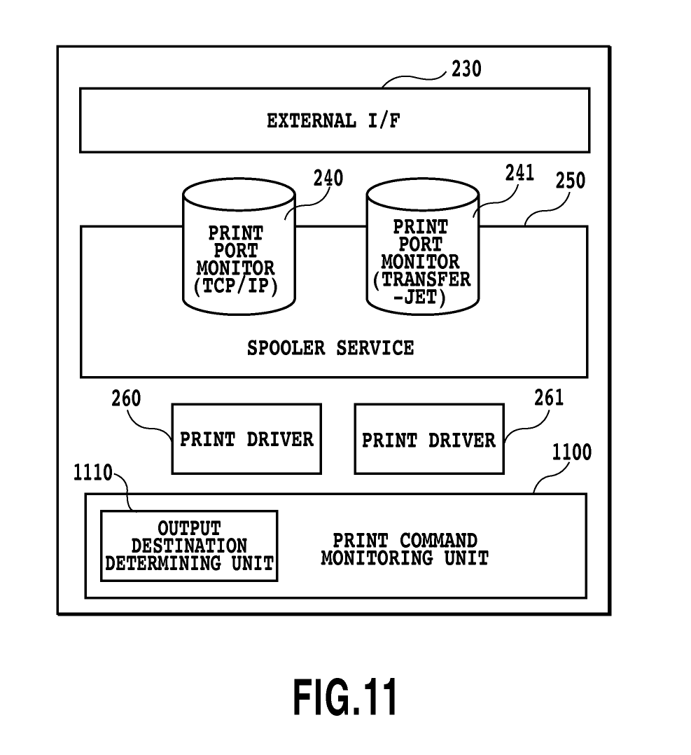

FIG. 11 shows an internal module structure of the client 200 for realizing the present embodiment. The client 200 is provided with the external I/F module 230, the print port monitors 240 and 241 communicating with the printer, the spooler service 250 for managing the monitors, and the printer drivers 260 and 261 for generating print data. Further, the client 200 is provided with a print command monitoring unit 1100 detecting that a user instructs a print, and the print command monitoring unit 1100 is provided with an output destination determining unit 1110 for determining whether or not the print is performed to an appropriate printer.

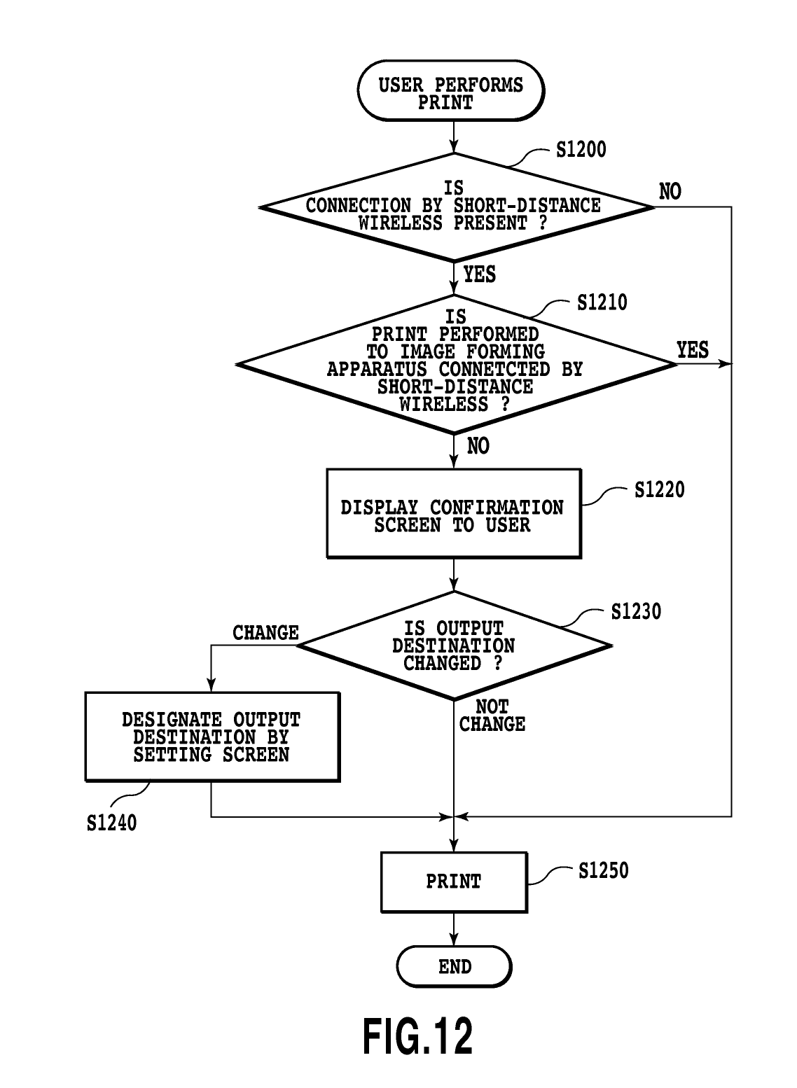

An internal operation of a client for realizing the present embodiment will be explained with reference to FIG. 10 and FIG. 11 as described above, and an operation flow chart of an output destination determining unit 1110 in FIG. 12.

When the command monitoring unit 1100 detects that a user instructs a print, the output destination determining unit 1110 confirms whether or not the client 200 is connected to the printer 100 by the short-distance wireless at present (S1200). As a result, when the short-distance wireless connection does not exist, the print of the user is performed by the printer set as the standard output destination at this point (S1250).

In a case where the short-distance wireless connection is detected, it is confirmed whether or not the set output destination is the printer 100 connected by the short-distance wireless by confirming the setting of the output destination for printing (S1210). As a result, when the set output destination is the printer 100 connected by the short-distance wireless, the print corresponding to an instruction of the user is performed by the printer 100 (S1250). When the set output destination is the printer not connected by the short-distance wireless, a confirmation screen of, for example, the popup dialogue 131 for confirming the output destination to the user is presented (S1220).

In a case where the user does not change the output destination to the confirmation screen (in a case where a Yes button of the popup dialogue 131 is clicked), a print is performed from the print set as the standard output destination (S1250). In a case where the user hopes to change the output destination on the confirmation screen (in a case where a No button of the popup dialogue 131 is clicked), the selective screen 130 for once more selecting the output destination is presented to the user to once more require the setting of the output destination (S1240). When the user designates the output destination, a print is performed from the printer of the designated output destination (S1250).

The client 200 in the present embodiment can prevent a risk that a user performs a print to an unintended printer by mistake by executing the above processing including the determination on appropriateness of the output destination.

### (Modification)

It should be noted that in a case where the external I/F module 230 includes an infrared ray port, a printer connectable by infrared ray communication may be set as the output destination of the client 200.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a printing medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-172439, filed Jul. 23, 2009, which is hereby incorporated by reference herein in its entirety.

What is claimed is:

1. An information processing apparatus connectable to plural image forming apparatuses comprising:
a unit configured to set a first image forming apparatus to a print output destination among the plural image forming apparatuses;
a detecting unit configured to detect a second image forming apparatus which is an image forming apparatus having a driver and connected by short-distance wireless communication;
a determining unit configured to, when the detecting unit detects the second image forming apparatus, determine whether or not the second image forming apparatus is set to the print output destination; and
a setting changing unit configured to, when the determining unit determines that the second image forming apparatus is not set to the print output destination, change the second image forming apparatus to the print output destination.

2. An information processing apparatus according to claim 1, wherein the setting changing unit is configured to restore the print output destination to the first image forming apparatus before the print output destination is set and changed to the second image forming apparatus in a case where the disconnection of the short-distance wireless communication of the second forming apparatus is detected by the detecting unit.

3. An information processing apparatus according to claim 1, wherein the short-distance wireless communication is connected by Transfer-Jet and/or Bluetooth.

4. An information processing apparatus according to claim 1, wherein the setting changing unit comprises:
a unit configured to, in a case where the detecting unit detects the plural image forming apparatuses connected by the short-distance wireless communication, determine each communication distance of the plural image forming apparatuses; and
a unit configured to select the image forming apparatus connected by the short-distance wireless communication having a shorter communication distance among the plural image forming apparatuses, as the print output destination.

5. An information processing apparatus connectable to plural image forming apparatuses comprising:
a unit configured to set a first image forming apparatus to a print output destination among the plural image forming apparatuses;
a detecting unit configured to detect a second image forming apparatus which is an image forming apparatus having a driver and connected by short distance radio communication;
a determining unit configured to, when the detecting unit detects the second forming apparatus, determine whether or not a print instruction by a user is a print instruction to set the second image forming apparatus to the print output destination; and
a unit configured to, when the determining unit determines that the print instruction by the user is not the print instruction to set the second image forming apparatus to the print output destination, perform a screen display for confirming the print output destination to the user.

6. An information processing apparatus according to claim 5, wherein the short-distance wireless communication is connected by Transfer-Jet and/or Bluetooth.

7. An information processing apparatus according to claim 1, further comprising:
a print port monitor for communicating with the image forming apparatus; and
a spooler service for managing the print port monitor,
wherein the detecting unit performs the detection by obtaining transport information of the print port monitor from the spooler service.

8. An information processing apparatus according to claim 1, wherein the detecting unit performs the detection by obtaining communication information from the image forming apparatus.

9. An information processing apparatus according to claim 1, wherein the detecting unit performs the detection by obtaining a connection situation of the short-distance wireless communication from an operating system of the information processing apparatus.

10. An information processing method in an information processing apparatus connectable to plural image forming apparatuses, the method comprising the steps of:
setting a first image forming apparatus to a print output destination among the plural image forming apparatuses;
detecting a second image forming apparatus which is an image forming apparatus having a driver and connected by short-distance wireless communication;
when the second forming apparatus is detected at the detecting step, determining whether or not the second image forming apparatus is set to the print output destination; and
when it is determined at the determining step that the second image forming apparatus is not set to the print output destination, changing the second image forming apparatus to the print output destination.

11. An information processing method in an information processing apparatus connectable to plural image forming apparatuses, the method comprising the steps of:
setting a first image forming apparatus to a print output destination among the plural image forming apparatuses;
detecting a second image forming apparatus which is an image forming apparatus having a driver and connected by short-distance wireless communication;
when the second forming apparatus is detected at the detecting step, determining whether or not a print instruction by a user is a print instruction to set the second image forming apparatus to the print output destination; and
when it is determined at the determining step that the print instruction by the user is not the print instruction to set the second image forming apparatus to the print output destination, performing a screen display for confirming the print output destination to the user.

12. A computer-readable printing medium having computer-executable instructions for performing an information processing method in an information processing apparatus connectable to plural image forming apparatuses, the method comprising the steps of:
setting a first image forming apparatus to a print output destination among the plural image forming apparatuses;
detecting a second image forming apparatus which is an image forming apparatus having a driver and connected by short-distance wireless communication;
when the second forming apparatus is detected at the detecting step, determining whether or not the second image forming apparatus is set to the print output destination; and
when it is determined at the determining step that the second image forming apparatus is not set to the print output destination, changing the second image forming apparatus to the print output destination.
